(19) United States
(12) Patent Application Publication
(10) Pub. No.: US 2018/0007516 A1
(43) Pub. Date: Jan. 4, 2018

(54) LOCATING A MOBILE DEVICE

(71) Applicant: PHILIPS LIGHTING HOLDING B.V., EINDHOVEN (NL)

(72) Inventors: XIAODONG GE, SHENZHEN (CN); JUN YAO, SHANGHAI (CN)

(21) Appl. No.: 15/540,427

(22) PCT Filed: Dec. 11, 2015
(86) PCT No.: PCT/EP2015/079350

§ 371 Date: Jun. 28, 2017

(30) Foreign Application Priority Data
Dec. 30, 2014 (CN) PCT/CN2014/095652
Feb. 12, 2015 (EP) 15154781.7

(51) Int. Cl. H04W 4/04; H04W 64/00

(52) U.S. Cl. CPC H04W 4/043; H04W 64/003

(57) ABSTRACT

A location system provides a location service for determining a location of a mobile device. A node of the location system comprises: a signal processing module, and a wireless interface which communicates wirelessly according to a standardized wireless networking protocol. The protocol defines a request message for sending a request from the mobile device to the node, the request message having a network ID field for specifying a network to which the request is directed. The wireless interface receives, from the mobile device, an instance of the request message including an ID of the location service, this being carried in the network ID field. The signal processing module detects the ID of the location service in this field, and in response captures a measurement of the received instance of the request, for use in determining the location of the mobile device in conjunction with measurements from other nodes.

### TECHNICAL FIELD

The present disclosure relates to a location service for determining the location of a mobile device.

### BACKGROUND

GPS (global positioning system) is a widely used technology for pin-pointing the user location of personal smart devices, such as smart mobile phones and mobile tablets. However, GPS relies on the mobile device receiving signals from satellites, which could be blocked by concrete structures, such as buildings, thus limiting indoor use. So-called indoor location services (e.g., assisted GPS, A-GPS) provide a supplement or even a substitute for GPS or other satellite-based geolocation services where the satellite signals are not reliable or even not reachable, especially inside a large building. Indoor location services work based on the mobile device receiving signals from RF beacon nodes located nearby. These could be pre-existing beacons that already exist for other purposes, such as Wi-Fi access points or base stations of a mobile cellular network (e.g., of a 3GPP network, such as GSM cell towers or 3G/LTE nodeBs); or could be dedicated anchor nodes of a dedicated location network.

A database on a location server stores the IDs and locations of multiple such beacon nodes in a certain area (e.g., GSM cell towers within range of a certain building or complex, and/or Wi-Fi access points or dedicated anchor nodes in the building or complex). In operation, the mobile device then measures a property of the signals received from a plurality of these nodes, such as received signal strength (e.g., RSSI), time-of-flight and/or angle-of-arrival, which can be used to determine relative RF distance from the mobile device. Given knowledge of the absolute location of the nodes looked up from the location database (e.g., the location on the globe, a map or a floor plan); one can calculate the location of the mobile device based on one or more suitable known techniques such as triangulation, trilateration, multilateration or fingerprinting. The calculation may be performed at the mobile device based on the measurements of the signals received from the nodes and the locations of the nodes as accessed from the database (a device centric approach), or the mobile device may report the measurements to the location server for the calculation to be reported there (a hybrid approach). Another possibility is that the nodes take measurements of a signal transmitted from the mobile device, and report the measurements to the location server to perform the location calculation (a network centric approach).

More RF nodes or a stronger signal strength will improve the reliability and accuracy of the calculation. For buildings with relatively weak GSM signals or few Wi-Fi access points, or such like, the location accuracy will be very low. One option is to deploy within the building a large number of low cost RF emitters which most mobile devices are compatible with, such as Bluetooth beacons, and the user can then use the location service based on these. However, the deployment and maintenance cost of such devices is not cheap, e.g., a Bluetooth device could be battery powered and need replacement after certain time, etc.

Recently, lighting control technology has advanced rapidly as the cost of wireless controllers has dropped. This makes it possible to deploy wireless lighting control systems on a large scale, e.g., over a large building or shopping floor, in order to reduce the energy consumption and provide diverse lighting control experiences. Using Wi-Fi for the wireless lighting control is seen by many as the future trend, due to its universal presence and mature networking technology.

Thus a Wi-Fi circuit may be integrated into each of a plurality of lamps in a given environment, in order to enable them to communicate with a Wi-Fi controller for the purpose lighting control. In this case, the capability to send and/or receive RF signals can also be exploited for an additional purpose of providing an indoor location service, based on calculating the RF signal strength or time-of-flight of signals transmitted between the lamps and the mobile device being located. A Wi-Fi circuit could even be included in each lamp primarily for this purpose, as opposed to being a secondary purpose of an existing circuit.

One option is to turn some or all of the Wi-Fi lamps into RF beacon emitters. The difficulty in using Wi-Fi lamps for RF beacon emitters is that the Wi-Fi lamps are conventionally Wi-Fi clients, not Wi-Fi access points. That is, there is no RF beacon being emitted out periodically from any of the Wi-Fi lamps, whereas Wi-Fi access points do emit a periodic beacon. According to the Wi-Fi standard, a Wi-Fi access point will periodically broadcast a beacon signal to the network, such that any Wi-Fi client device in range will be able to detect the Wi-Fi access point and be able to connect to the Wi-Fi network through the Wi-Fi access point. The Wi-Fi client devices will only listen to the Wi-Fi beacon signals in order to join a network, and maintain the connection during normal communication time. According to the standard, the Wi-Fi client devices will not have the behavior of emitting periodic beacons, and thus other devices will not be able to detect Wi-Fi client devices if the devices are not in active communications with other devices.

To allow the Wi-Fi lamps to emit beacon signals, it is possible to operate all the Wi-Fi lamps as Wi-Fi access points, or in Wi-Fi access point plus Wi-Fi client mode. However, this will generate large amounts of wireless traffic in the available RF channel, especially for buildings with hundreds or thousands of Wi-Fi lamps. If every lamp periodically emits a RF beacon, this will reduce the network bandwidth significantly for normal Wi-Fi traffic.

### SUMMARY

It would be desirable to activate the RF beacons only when the user needs the location service, and only from those lamps that are near the user: the mobile device will send out a triggering command through Wi-Fi, and all the lamps will listen for this triggering command, and once received, the lamp will start sending the RF beacons for a while.

To support most practical use cases, it would also be desirable that a stranger who walks into an unfamiliar building with an unknown Wi-Fi network can use the location service right away. But on the other hand, the building manager may not want everyone connected to the building Wi-Fi network just for the location service.

If the mobile device is not connected to the Wi-Fi network, there is no standard way to send a command to the network—instead a proprietary method or protocol would have to be implemented for all the mobile devices.

Another difficulty that may prevent the usefulness of a location service based on Wi-Fi lamps is that it may require a change to the existing indoor location business model of the mobile devices or the eco-system. E.g., currently, each major mobile operating system vendor has its own central Wi-Fi location database to maintain the location information of all Wi-Fi access points, which is usually not open for private use by third parties, and each of the operating system vendors provides their own mapping service to use the location database. It is sometimes not possible for the third party to provide an in-building navigation service with private Wi-Fi access points. For example, many APIs of the operating system may be restricted, and as such it may not be possible to retrieve all the Wi-Fi network SSIDs and the associated RF signal strengths. Thus it may not be possible to calculate the distance to the known Wi-Fi lamps.

Similar considerations may also apply to other nodes equipped with Wi-Fi, such as presence sensors, motion detectors, daylight sensors, smoke alarms, air conditioning units, etc.

To overcome one or more of the above issues, it would be desirable to rely only on the Wi-Fi standard or other wireless standard, and follow strictly the rules laid down by the standard and operating system. On the other hand, a way will need to be found to fit the desired mechanism into the standard.

According to one aspect disclosed herein, there is provided a node of a location system, the location system providing a location service for determining a location of a mobile device. The node comprises: a wireless interface configured to communicate wirelessly according to a standardized wireless networking protocol, and a signal processing module operatively coupled to the wireless interface. Said protocol defines a request message for sending a request from the mobile device to said node, the request message having a network ID field for specifying a network to which the request is directed. The wireless interface is operable to receive, from the mobile device, an instance of said request message including in said field an ID of said location service (i.e., the message includes the location service ID, and this ID of the location service is carried in said field of the message). Further, the signal processing module is configured to detect the ID of the location service in said field, and in response to said detection to measure a property (i.e., to capture a measurement) of the received instance of said request message, for use in determining the location of the mobile device in conjunction with information on measurements taken by other nodes of the location system based on instances of the request message received by the other nodes. For instance, the measurement of the received instance of the request message may comprise a measurement of its received signal strength, its time of flight, and/or its angle of arrival. E.g., in the case of signal strength, the measurement may take the form of an RSSI (received signal strength indication).

The taking of the measurement is triggered by the detection of the location service's ID in the network ID field of the standard request message as sent from the mobile terminal, preferably being directly triggered by this with no other message from the mobile device being required to trigger the measurement. Preferably the standard used is Wi-Fi, and the request message is a standard message of the Wi-Fi standard. In embodiments, the network ID field is the SSID field, so that the ID included in the request message is a “pseudo” SSID (which may or may not be the ID of an actual existing network at the time the request is sent—see below). Further, in embodiments the request message is the Wi-Fi probe request designed for probing for Wi-Fi networks. Thus the invention advantageously exploits an existing message of an existing protocol such as the probe message of the Wi-Fi protocol to trigger a different function that the message was not designed for in the standard, namely to trigger a measurement by the receiving node for use in a location calculation.

Note that the taking of the measurement of the desired property (e.g., RSSI) in response to the detection of the location service ID can be implemented by capturing the measurement in a number of possible ways. In some implementations, the actual sampling of the property may be triggered in response to said detection. However, in other possible implementations, the temporary sampling of the property per se may be an action that is being performed anyway, automatically by the node in response to receiving an instance of the request message regardless of the content of the ID field (e.g., a Wi-Fi client or access point would automatically sample the RSSI when it receives a probe request); but when it comes to substantively taking the measurement in response to detecting the location service ID in said field, this means the measurement is performed by registering the already-sampled property (e.g., RSSI) to be used in the location calculation. Either way, the detection of the location service ID in said field thus triggers the node to act so that the measurement is used as part of the location calculation. E.g., embodiments, the detection of the location service ID in said field also triggers the node to send information on the measurement to a location server, where the location calculation may be performed (see below).

Preferably each of said node and the other nodes takes the form of a luminaire equipped with Wi-Fi or another such wireless standard. Alternatively, one or more of these nodes may take the form of another Wi-Fi or wirelessly equipped node such as a presence sensor, motion sensor, smoke alarm, daylight sensor, air conditioning unit, etc., or a dedicated node of the location system.

The actual calculation of the mobile device's location (e.g., the triangulation, trilateration, multilateration or fingerprinting process) is preferably performed at a location server (also referred to elsewhere herein as a managing server). In this case the signal processing module of said node is configured to submit information on said measurement to a location server, for the location server to perform the determination of the mobile device's location based on the submitted information and the information on the measurements from the other nodes. For example, the signal processing module may be configured to calculate a distance between said node and the mobile device based on said measurement, and the information submitted to the server comprising the distance as measured by the signal processing module of said node. Alternatively, the information submitted to the server may comprise the “raw” measurement itself without calculation of a distance between said node and the mobile device, for the distance to be calculated at the location server. In yet further embodiments, the location need not be calculated at the location server. E.g., the other nodes could report their measurements or calculated distances to said node, for the signal processing module of that node to perform the location calculation; or said node and the other nodes could report their measurements or distances to the mobile device, for the location to be calculated there.

In embodiments, at least subsequent to receiving said instance of the request, the node may be operable as an access point to provide access to a wireless network of the wireless networking protocol using said wireless interface, based on a network ID of the wireless network; and the signal processing module may be configured to return the determined location of the mobile device to the mobile device via said wireless access point and wireless network (e.g., to provide the determined location back from the location server), based on the mobile device connecting to said access point using said network ID. Alternatively, it is not excluded that neither said node nor any of the other nodes are used to provide the determined location from the location server to the mobile device, the determined location instead being provided from the location server to the mobile device via a different type of network than formed using said networking protocol, e.g., via a mobile cellular network such as a 3GPP network.

Preferably, at least at the time of receiving said instance of the request message from the mobile device, the ID of the location service is not an ID of any currently available network of the wireless networking protocol, or at least not an ID of any network of the wireless networking protocol for which said node currently functions as a wireless access point. Hence the ID (e.g., the pseudo SSID) is not an ID of any currently existing network (at least not in the environment in question), but instead the network ID field is used for another purpose of identifying the location service.

In embodiments, the signal processing module may be further configured to automatically activate the node to begin functioning as said wireless access point in response to said detection. Thus when no location service is required by the mobile device, the node does not act in access point mode and so does not regularly emit beacon signals (e.g., as defined for access points in the Wi-Fi standard). Only when triggered by the request message containing the location service ID (e.g., Wi-Fi probe message with pseudo SSID) does the node activate.

In embodiments, the ID of the location service is the network ID of said wireless network, such that although the ID in the request is not initially the ID of any existing network, it becomes so when the access point is activated. Alternatively the network ID of said wireless network may be different than the ID of the location service, such that the ID of the location service is never a network ID of said wireless networking protocol (i.e., never an ID of a network that exists in the environment in question).

In embodiments, the signal processing module may be configured to only activate said node to function as said wireless access point if spatially closer to the mobile device than any of said other nodes (wherein otherwise one of the other nodes provides the access point). Thus the number of nodes that become access points is limited, again reducing beaconing so as not to flood the environment with too much traffic.

Preferably, said node is configured not to broadcast the network ID of said wireless network (a “hidden” network in Wi-Fi terminology).

In embodiments, the signal processing module may be configured to deactivate the node from functioning as said wireless access point after providing the determined location to the mobile device, and/or the signal processing module may be configured to deactivate the node from the functioning as said wireless access point after a time-out period.

According to another aspect of the present disclosure, there is provided an arrangement of nodes, each configured in accordance with any of the nodes disclosed herein.

In embodiments, each of a plurality of these nodes is configured to listen for the request message on a different channel of the wireless networking protocol (e.g., different frequency channels, such as different non-overlapping frequency channels or different OFDM channels). According to another aspect disclosed herein, there is provided a computer program product for use in a location system, the location system providing a location service for determining a location of a mobile device, and the computer program product comprising code embodied on a computer-readable medium and configured so as when executed on a node of the location system to perform operations of: operating a wireless interface of said node to communicate wirelessly according to a standardized wireless networking protocol, said protocol defining a request message for sending a request from the mobile device to node, the request message having a network ID field for specifying a network to which the request is directed; receiving, from the mobile device, an instance of said request message including an ID of said location service, the ID of the location service being carried in said field; detecting the ID of the location service in said field; and in response to said detection, capturing a measurement of the received instance of said request message, for use in determining the location of the mobile device in conjunction with information on measurements taken by other nodes of the location system based on instances of the request message received by the other nodes.

In embodiments, the computer program product may be further configured to perform operations in accordance with any of the functionality of the node features disclosed herein.

According to another aspect disclosed herein, there is provided a method of operating a node of a location system, the location system providing a location service for determining a location of a mobile device, and the method comprising: operating a wireless interface of said node to communicate wirelessly according to a standardized wireless networking protocol, said protocol defining a request message for sending a request from the mobile device to the node, the request message having a network ID field for specifying a network to which the request is directed; receiving, from the mobile device, an instance of said request message including an ID of said location service, the ID of the location service being carried in said field; detecting the ID of the location service in said field; and in response to said detection, capturing a measurement of the received instance of said request message, for use in determining the location of the mobile device in conjunction with information on measurements taken by other nodes of the location system based on instances of the request message received by the other nodes.

In embodiments, the method may further comprise steps in accordance with any of the functionality of the node or system features disclosed herein.

### BRIEF DESCRIPTION OF THE DRAWINGS

To assist understanding of the present disclosure and to show how embodiments may be put into effect, reference is made by way of example to the accompanying drawings in which:

FIG. 1 schematically illustrates an infrastructure of a typical A-GPS location service system,

FIG. 2 schematically illustrates a radio based trilateration,

FIG. 3 is a flow chart of a calculation for radio based trilateration,

FIG. 4 schematically illustrates an infrastructure of a location system implemented based on Wi-Fi lamps,

FIG. 5 is a schematic block diagram of a Wi-Fi lamp,

FIG. 6 schematically illustrates communications between elements of a location system implemented based on Wi-Fi lamps,

FIG. 7 shows a sample of a Wi-Fi probe packet with MAC address and SSID,

FIG. 8 shows a sample of a Wi-Fi association request packet with MAC address and SSID,

FIG. 9 schematically illustrates a trilateration based on Wi-Fi lamps,

FIG. 10 illustrates a circle-circle intersection,

FIG. 11 shows screen-shots of an operating system upon entering a hidden network SSID, and

FIG. 12 shows a screen-shot of an operating system displaying MAC address information.

### DETAILED DESCRIPTION OF EMBODIMENTS

In embodiments, the present invention uses Wi-Fi lamps to calculate the mobile device location instead of the calculation being performed at the mobile device, and a special protocol is provided based on existing messages of the Wi-Fi standard in order for the mobile device to send a Wi-Fi command to the air to trigger the calculation in the lamps. This protocol can be implemented in all existing mobile devices with Wi-Fi capability, that is, by using a standard protocol for a different purpose, to make it possible to implement this invention universally. Otherwise, one would need to ask each of the mobile device operating system providers to upgrade the operating system, which is normally not possible, due to the highly diverse mobile device market.

The indoor location service system involves three types of devices: a mobile device such as a smart phone, a plurality of Wi-Fi lamps, and a managing server for the Wi-Fi lamps (a location server). The smart phone shall register a pre-defined “pseudo” Wi-Fi network SSID, which the Wi-Fi lamps can recognize. Once this special network SSID is entered into the smart phone, for registering a hidden SSID network entry, then if the smart phone tries to connect to the pseudo Wi-Fi network with this special SSID, the Wi-Fi active scan will be used. Even though the pseudo Wi-Fi network does not exist, the active scan from the smart phone will still be able to broadcast the probing request packet.

Once the active scan is started, those Wi-Fi lamps which can pick up the broadcasts of this special SSID will start the location calculation procedure, in which the nearest Wi-Fi lamp is elected to act as a simplified Wi-Fi access point for supporting data exchange between the Wi-Fi lamp network and the smart phone. The smart phone will be identified by the unique MAC address (or other unique identifier depending on the specific communication protocol) embedded in the SSID probing request packet, and the calculation results will be sent to a Wi-Fi lamp managing server. In turn the location information can be pushed to the smart phone via a pre-installed service in the phone, or the smart phone can pull the information from the server.

The elected Wi-Fi lamp switches into a simplified Wi-Fi access point mode, in which it sends out Wi-Fi periodic beacons mimicking a standard Wi-Fi access point. The beacon will carry minimal information to reduce the traffic impact on the available network channel, such as by only including the MAC address and capability of the access point, but with no SSID being embedded in the beacon so that this simplified Wi-Fi access point acts as a hidden Wi-Fi network, to prevent connection requests from other Wi-Fi clients that are not location service oriented. The beacon will also help to forward the packet exchanges between the smart phone and the Wi-Fi lamp managing server, such as packets for the purpose of: the Wi-Fi association and disassociation process, DHCP (dynamic host configuration protocol), DNS (domain name service), TCP/IP transport, and/or the location service (information or database access). If requested by the Wi-Fi lamp managing server, the Wi-Fi lamp can stop this simplified Wi-Fi access point mode, by disassociating the connected client devices and stopping sending out the beacons.

The Wi-Fi lamp managing server is used to decide which of the Wi-Fi lamps is to switch to the simplified Wi-Fi access point mode and when to switch it off; and to decide which Wi-Fi lamp is allowed to associate or disassociate with a smart phone; and to collect the distance calculation results from all Wi-Fi lamps and perform the actual location calculation (e.g., trilateration). The server will also implement the Wi-Fi protocols for all the simplified Wi-Fi access points in all Wi-Fi lamps, so that the smart phones will be able to connect to this Wi-Fi lamp network and communicate with the server to retrieve the location calculation results, and obtain other information, like the building structure for navigation.

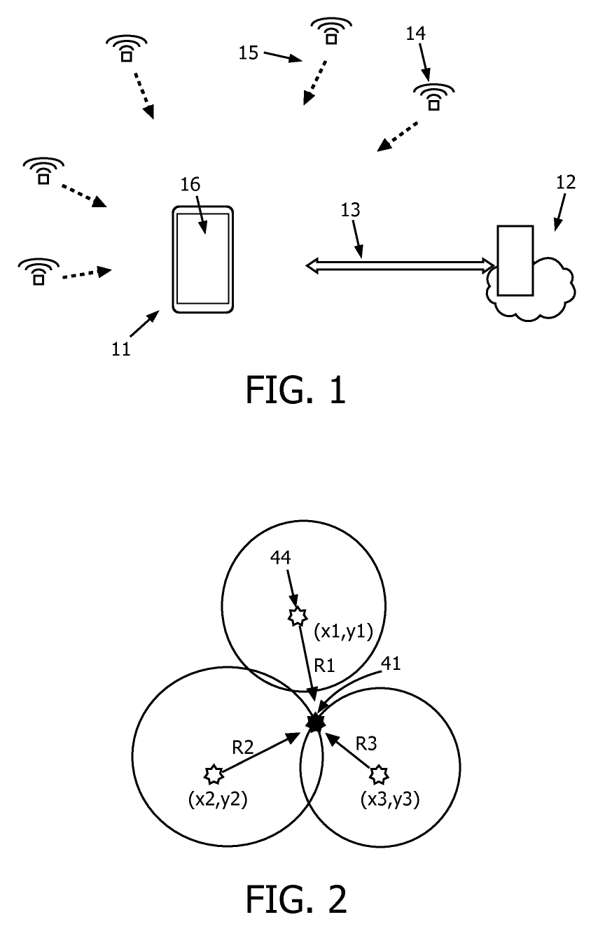

Some further exemplary details are now discussed in more detail in relation to FIGS. 1 to 12.

FIG. 1 illustrates an infrastructure of a conventional assisted-GPS (A-GPS) location service system. The system comprises: a mobile phone 11 or other such mobile device (e.g., tablet), a plurality of GSM cell towers or Wi-Fi access points 14, and a central server 12 with a database of known ones of these GSM cell towers or Wi-Fi access points. The mobile phone 11 communicates with the central server 12 via a data link 13 in order to access the location database. An RF beacon 15 is sent from each cell tower or access point 14, received by the mobile phone 11 if in range. The resulting location information is displayed on a user interface 16 (e.g., screen) of the mobile phone 11.

The current A-GPS service is reasonably suitable for areas with a low density of buildings or small buildings, since the GSM signal or Wi-Fi signal can easily penetrate a few walls, with relatively little interferences or reflections. However, when it is used inside a large building, the signals are weak and experience interference, and more RF beacon devices are needed to improve location accuracy. The available infrastructure of Wi-Fi lamps in the building can provide a solution to this problem, but operating the Wi-Fi lamps using the current A-GPS model may experience additional problems, such as: (i) beacons from many Wi-Fi lamps could jam the Wi-Fi network (thus it would be desirable not to constantly transmit beacons from all Wi-Fi lamps); (ii) the communication between the mobile phone and the network in which Wi-Fi lamps are connected is not always possible, since a user may walk into a new building where the Wi-Fi network is unknown or restricted (thus it would be desirable not to have to depend on a normal Wi-Fi connection); and/or (iii) current mobile smart phones in the market are very diverse, and it is not possible to implement a Wi-Fi protocol level change to every device to be able to access this Wi-Fi lamps based location service (thus it would be desirable not to use any proprietary or non-standard protocol).

The following embodiments provide a method for a mobile smart phone (or the like) to communicate the need for an indoor A-GPS service, based on the Wi-Fi lamp infrastructure installed in a large building, with this method being able to be implemented universally at the application layer in all smart phones or smart devices.

The Wi-Fi standard requires a client device to join a network to establish the network connection. The joining requires the device to scan the air for network beacons sent by different Wi-Fi access points. This scan can be passive or active. In the passive scan, the client device will listen for all the periodical broadcasts from Wi-Fi access points, and based thereon form a network list. In the active scan, the client device will probe whether a specific network exists nearby, especially to probe for a hidden SSID network. The client device will broadcast the probing request or association request packet to the air, and any Wi-Fi access point with a matching network will respond to the client device. This probing request or association request packet carries the client device MAC address along with the network name, or so-called SSID (Service Set ID). The client device MAC address is a unique number and is used to identify the client device, and the SSID is the name of a network which is used to distinguish Wi-Fi networks which coexist in the same location or nearby locations.

The following embodiments use the Wi-Fi client active scan protocol to communicate with the Wi-Fi lamp network for triggering the location service. The client device shall register a pre-defined “pseudo” Wi-Fi network SSID, which the Wi-Fi lamps can recognize. This special Wi-Fi network SSID name string shall preferably take a relatively long form to avoid a potential clash with a same name used for other purposes; for example, the Wi-Fi network SSID for the location service could be “[Location Service] Wi-Fi lamps”.

Once this special network SSID is entered into a smart phone, for registering a hidden SSID network entry, then if the smart phone tries to connect to the pseudo Wi-Fi network with this special SSID, the active scan will be used. Though the “pseudo” Wi-Fi network does not exist, the active scan from the smart phone will still be able to send the probing request packet to the air.

Once the active scan is started, those Wi-Fi lamps which can pick up the broadcasts of this special SSID will start the location calculation procedure, in which a nearest Wi-Fi lamp is elected to act as a simplified Wi-F access point for supporting data exchange between the Wi-Fi lamp network and the smart phone. The Wi-Fi network newly made available from this newly-activated access point could use the “pseudo” SSID as its SSID, which up until that point did not correspond to any existing network, but now does; or alternatively this Wi-Fi network could use a different SSID, such that the SSID never corresponds to any existing Wi-Fi network.

The smart phone will be identified by the unique MAC address embedded in the SSID probing request packet. The calculation results will be sent to a Wi-Fi lamp managing server (which acts as a location server), and in turn the location information can be pushed back to the smart phone via a pre-installed service in the phone, or the smart phone can pull the information from the server.

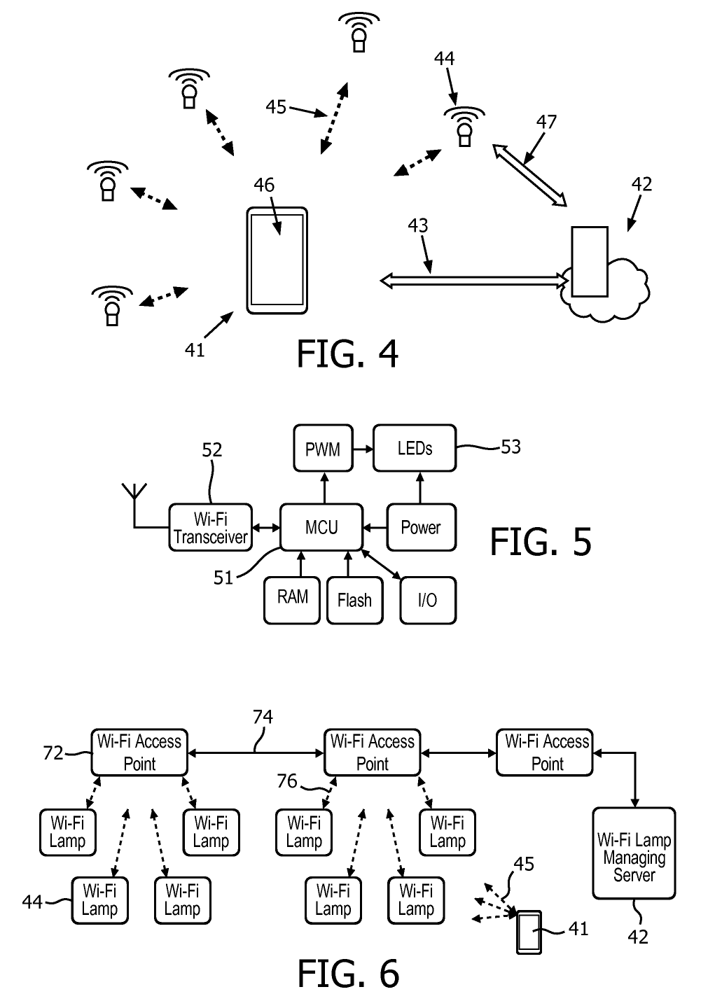

FIG. 4 illustrates the infrastructure of an A-GPS location service system based on Wi-Fi lamps, in accordance with embodiments disclosed herein. The system comprises a mobile smart phone 41 (or other mobile device), a plurality of lamps 44, and a Wi-Fi lamp managing server 42 comprising a location database of some or preferably all of the lamps 44 (thereby providing the function of at least a location service server, and optionally other functionality such as lighting control). Each of the lamps 44 is equipped with a Wi-Fi interface, at least comprising a Wi-Fi receiver and preferably a Wi-Fi transceiver (transmitter & receiver). Note: the term “lamp” is sometimes used in the art to refer specifically to the lighting element (e.g., an LED string or array, or filament bulb), while strictly “luminaire” is the term used to refer to the unit comprising the lighting element plus associated housing, socket and/or support, which would also contain the Wi-Fi interface. However, the term “lamp” is used herein as a commonplace short-hand for the luminaire including lighting element and associated hardware, which in this case comprises the Wi-Fi interface.

The mobile phone 41 communicates with the Wi-Fi lamp server 42 via a data link 43, e.g., via a Wi-Fi network 47 provided by one or more of the Wi-Fi lamps 44 or via a separate network such as a mobile cellular network (e.g., a 3GPP network such as a GSM network, 3G network, LTE network or the like). The Wi-Fi message exchange 5 between the smart phone and the Wi-Fi lamp also occurs via Wi-Fi. The mobile phone 41 is installed with a Wi-Fi location service app 46, which is used to display the location of the mobile phone 41 once determined, e.g., on a map or floorplan.

FIG. 5 shows a block diagram of the Wi-Fi lamp 44. The lamp (luminaire) 44 comprises: a lighting element 53 such as a string or array of LEDs, the Wi-Fi interface (transceiver) 52 for sending and receiving the Wi-Fi signals, and a signal processing module 51 in the form of a microprocessor arranged to retrieve and run suitable code from one or more memory devices of the lamp 44 (or alternatively some or all of the signal processing module could be implemented in dedicated hardware circuitry, or configurable or reconfigurable hardware circuitry such as a PGA or FPGA).

FIG. 6 provides a communication diagram of the Wi-Fi lamp based A-GPS system in accordance with embodiments. As discussed in relation to FIG. 4, the mobile phone 41 Wi-Fi lamps 44 communicates message 45 with the lamps 44 via the Wi-Fi protocol. The system may further comprise one or more dedicated Wi-Fi access points 72 (e.g., wireless routers each comprising a Wi-Fi access point), which may or may not additionally be used as nodes of the location system. In embodiments, each of one or more groups of the lamps 44 connects to a local one of the dedicated access points 72 via a first, Wi-Fi connection 76; and the dedicated access points 72 connect to the location server 42 via a second, Wi-Fi or wired connection 74. Via the first and second connections 76, 74, this enables communication between the lamps 44 and location server 42; and between the mobile phone 41 and location server 41 (by forming a Wi-Fi connection to one of the lamps 44 or one of the dedicated access points 72).

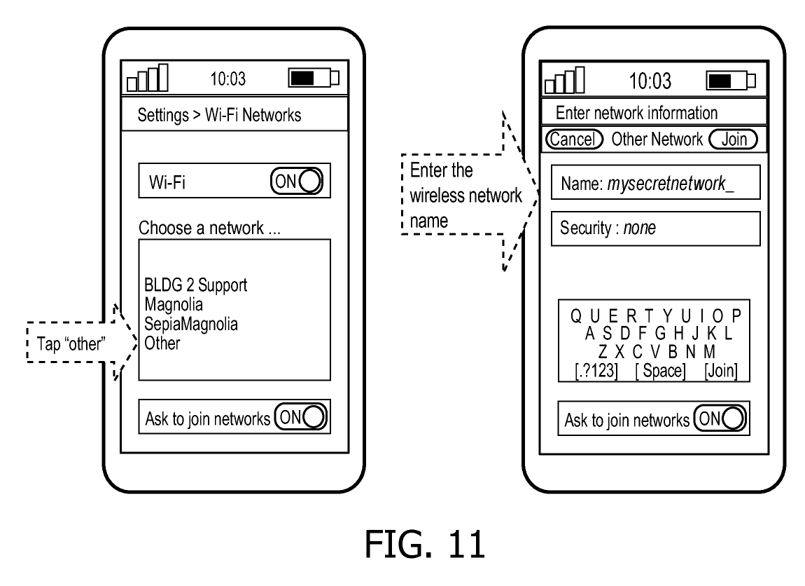

The entire process in the smart phone 41 can be manually operated, or can use a software program to automatically carry out some or all of the steps. First the special Wi-Fi network SSID is entered into the mobile phone for a hidden Wi-Fi network, e.g., being entered manually by the user into an operating system of the mobile device 11 (see FIG. 11) or into the app, or being entered automatically by the app. The app then asks the mobile phone 21 to connect to the pseudo Wi-Fi network of this special SSID, causing it to send out a Wi-Fi probe request with this pseudo SSID. The location service in the Wi-Fi lamps 44 is triggered by this special SSID, thus triggering the location calculation. The resulting location information will be held by the server 42, to be sent to the app on the mobile phone 41 via data link 43 (either on a push or pull basis).

The Wi-Fi lamps 44 comprise embedded Wi-Fi technology configured according to the Wi-Fi protocol. According to the present application, this can be modified so that each lamps listens for a Wi-Fi probe request containing the pseudo SSID of the location service in the SSID field of the request; and in response, one of the lamps 44 that detects this is then activated to begin acting as a special or simplified Wi-Fi access point, to allow the calculated location to be delivered from the location server 41 to the app on the mobile phone 41. For example this may be the lamp 44 detected to be physically closest to the mobile phone 41. This simplified access point preferably exchanges minimum data between Wi-Fi lamps and the smart phone 41, and does not broadcast its SSID. Note: the SSID of the Wi-Fi network provided by this newly-activated access point (which the mobile phone 41 uses to connect to the access point to obtain the location from the location server 42) may or may not be the same as the pseudo SSID in the probe request used to trigger the location measurement. If the two are different, the app may include a prompting message to the user to connect to a network with different SSID for the service, which adds one more step in the procedure.

The Wi-Fi standard requires the probing request to be sent on all Wi-Fi channels for a matching access point operating on the particular channel. This process may take quite a long time since each channel needs to be probed. The Wi-Fi lamps 44 on the other hand can advantageously shorten this process by placing different nearby Wi-Fi lamps onto different Wi-Fi channels, so that all Wi-Fi channels will be monitored to quickly pick up the location service requests generated from passing mobile phones 41. The Wi-Fi lamps are usually densely installed on the ceiling, for example 1 lamp per square meter, which can sufficiently support capturing all Wi-Fi channels and still meet the requirements of three or more Wi-Fi lamps 44 on one channel for triangulation or trilateration.

The operation of the Wi-Fi lamps 44 may be as follows. The Wi-Fi protocol is modified in each of the Wi-Fi lamps 44 (but still without breaking the rules of the standard) in order to listen for the broadcast of the special SSID. Also, the Wi-Fi channel to monitor is specified in each lamp 44. E.g., to cover all the 13 Wi-Fi 11 g channels, preferably 4×13=52 Wi-Fi lamps or more, and at least 3×13=39, should be installed on the ceiling of a given room, building or environment so as to be available within range of a mobile device 41 in that room, building or environment (preferably each channel is monitored by four or more dedicated lamps, or at least 3, in order to make triangulation or trilateration possible based on any one of the 13 channels alone; otherwise, with fewer lamps, the channels can instead be scanned sequentially, which is also a possibility, but will be slower). For a large building, this number of Wi-Fi lamps 44 shall generally not be a problem. Once the special SSID is picked up, the received signal strength (e.g., RSSI) is used to calculate the distance to the mobile phone 41, and this information plus the received MAC address in the broadcast and the Wi-Fi lamp ID are sent to the Wi-Fi lamp managing server (location server) 42. The Wi-Fi lamp managing server 42, if it receives three or more reports the distance information between the mobile phone identified by the MAC address and three or more respective Wi-Fi lamps 44 with specified lamp IDs, the server 42 will then to look through the lamp database for the known lamp locations, and start the trilateration. The server 42 will then store the calculation result in the server 42 and associate it with the mobile phone 41 by the MAC address of the phone 41.

As mentioned, once the location process is triggered, one of the lamps 44 activates as a Wi-Fi access point. The mobile phone 41 associates with this based on the Wi-Fi standard protocol, and thereby connects to the Wi-Fi network to which the access point provides access, which is identified within the Wi-Fi protocol by a particular SSID. This connection and network are then used to allow the calculated location to be returned from the location server 42 to the mobile phone 41. Preferably this SSID is not broadcast or advertised by the lamp 44, and as such the network in question is a hidden Wi-Fi network—mainly because in embodiments this network is also not a fully functional Wi-Fi network which provides Internet access, and in embodiments it is dedicated to the location service (i.e., its functionality is restricted to providing the location service).

According to the Wi-Fi protocol, all access points will periodically emit beacons, which has a mandatory field called the BSSID (the MAC address of the AP), and an optional SSID. The SSID is used for the passive scan process performed by a Wi-Fi client in order to discover the networks nearby, usually for a human to read. The BSSID is used to identify the network, and is used by the active scan (a hidden SSID network needs an active scan), and is used by the machine as opposed to the human. The mobile phone 41 in the present case will use the active scan to probe the network, and the network will respond with the BSSID and the SSID. The mobile phone 41 will then join the network (it could be hidden or not hidden, but is preferably hidden). After that, the SSID is not used anymore, and only BSSID is used to check whether the beacon is still there; otherwise, if the beacon is missing for certain time, the mobile phone 41 will assume the network is gone. If the network created by the Wi-Fi lamp 44 chooses to broadcast the SSID along with the beacon (i.e., so the network is not hidden), the mobile phone 41 will capture the broadcasted SSID and connect to the network immediately, there is no active scan needed. In any case, the mobile phone 41 will send packets to the air, either it is the active scan probe packet (hidden SSID), or the normal network connection packet (non-hidden SSID), and the Wi-Fi lamp 44 will capture those packets and provide the location service.

Note that if a hidden Wi-Fi network is created by a first mobile or device phone in using the location service, then any second mobile phone or device will still need to use the active scan technique as mentioned above if it is to use the location service. The same or a different Wi-Fi lamp will respond to the second mobile phone according to exactly the same procedure as for the first mobile phone. If a normal (non-hidden) Wi-Fi network is selected for providing the location service, then depending on the distance (received signal strength) of the second mobile phone to the Wi-Fi lamp which is providing the access point service: (i) if the second mobile phone is close to the said Wi-Fi lamp, the mobile phone's connection request to the Wi-Fi lamp will be granted; but (ii) if the second mobile phone is far away, the mobile phone's connection request can be rejected, and instead, a different and nearby Wi-Fi lamp may activate as the Wi-Fi access point mode, and the mobile phone may select the latter Wi-Fi lamp for connection since it will provide a stronger signal.

As an aside, note also therefore that while it has been said above that the SSID is not an ID of any currently existing or available network, or that the Wi-Fi network to which the node provides access does not currently exists at the time of sending the probe request, or that the node is not currently functioning as an access point at that time, or the like; in fact in the scenario of two or more mobile devices, i.e., where the first device is using the location service from the node and then a second mobile device comes along to use the service, then the network in question does already exist when the second device sends its probe request (and if the pseudo SSID is used as the network ID for that network, the pseudo SSID is the ID of an existing or currently available network when the second device sends its probe request). However, this of course does not stop the above-reference statements being true from the perspective of the first mobile device.

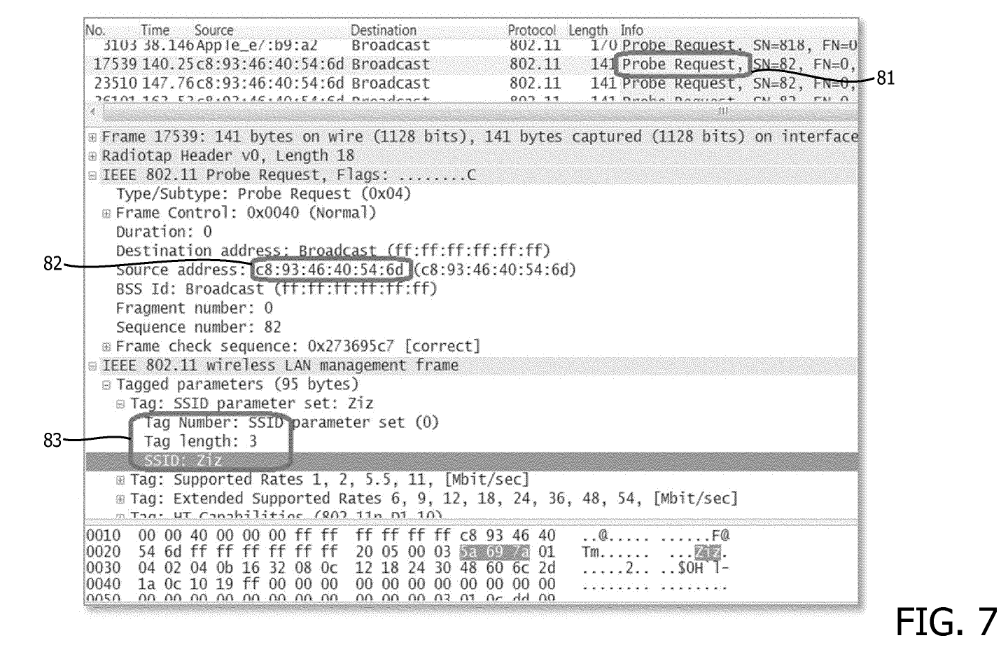

FIG. 7 shows a sample of a Wi-Fi probe request packet with MAC address and SSID in accordance with one example disclosed herein. The following shows the Wi-Fi (IEEE 802.11) Probe Request packet frame body format.

| Order | Information |
|---|---|
| 1 | SSID |
| 2 | Supported rates |
| 3 | Request information |
| 4 | Extended Supported Rates |
| 5 | DSSS Parameter Set |
| 6 | Supported Operating Classes |
| 7 | HT Capabilities |
| 8 | 20/40 BSS Coexistence |
| 9 | Extended Capabilities |
| 10 | SSID List |
| 11 | Channel Usage |
| 12 | Interworking |
| 13 | Mesh ID |
| Last | Vendor Specific |

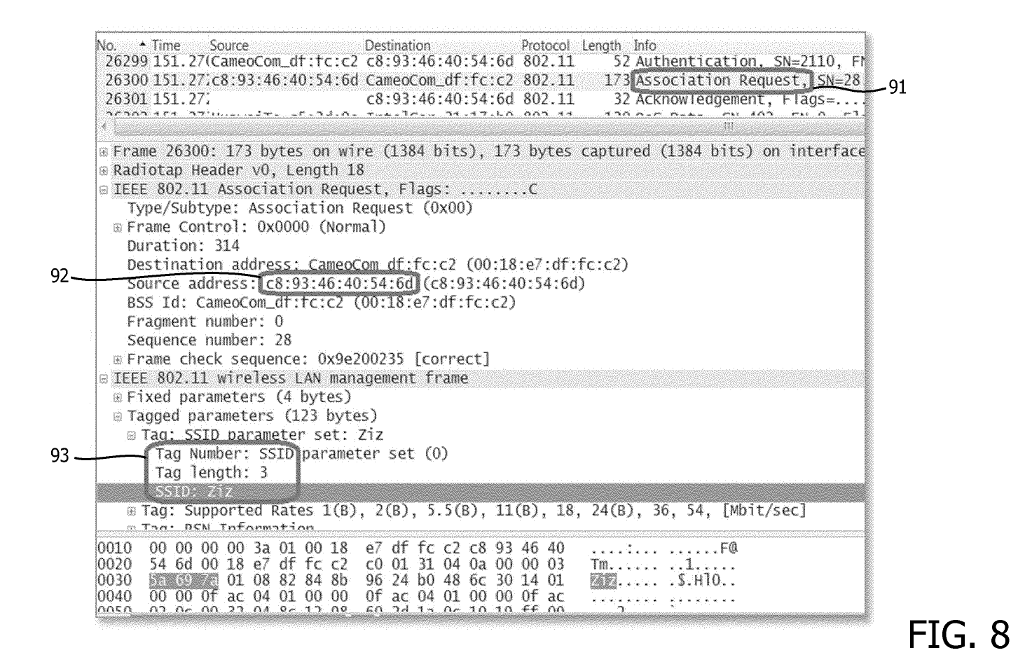

FIG. 8 shows a sample of a Wi-Fi association request packet with MAC and SSID in accordance with an example of the present disclosure. The following shows the Wi-Fi Association Request packet frame body format.

| Order | Information |
|---|---|
| 1 | Capability |
| 2 | Listen Interval |
| 3 | SSID |
| 4 | Supported rates |
| 5 | Extended Supported Rates |
| 6 | Power Capability |
| 7 | Supported Channels |
| 8 | RSN |
| 9 | QoS Capability |
| 10 | RM Enabled Capabilities |
| 11 | Mobility Domain |
| 12 | Supported Operating Classes |
| 13 | HT Capabilities |
| 14 | 20/40 BSS Coexistence |
| 15 | Extended Capabilities |
| 16 | QoS Traffic Capability |
| 17 | TIM Broadcast Request |
| 18 | Interworking |
| Last | Vendor Specific |

The following shows the Wi-Fi Beacon packet frame body format.

| Order | Information |
|---|---|
| 1 | Timestamp |
| 2 | Beacon interval |
| 3 | Capability |
| 4 | SSID |
| 5 | Supported rates |
| 6 | Frequency-Hopping (FH) Parameter |
| | Set |
| 7 | DSSS Parameter Set |
| 8 | CF Parameter Set |
| 9 | IBSS Parameter Set |
| 10 | Traffic indication map (TIM) |
| 11 | Country |
| 12 | FH Parameters |
| 13 | FH Pattern Table |
| 14 | Power Constraint |
| 15 | Channel Switch Announcement |
| 16 | Quiet |
| 17 | IBSS DFS |
| 18 | TPC Report |
| 19 | ERP |
| 20 | Extended Supported Rates |
| 21 | RSN |
| 22 | BSS Load |
| 23 | EDCA Parameter Set |
| 24 | QoS Capability |
| 25 | AP Channel Report |
| 26 | BSS Average Access Delay |
| 27 | Antenna |
| 28 | BSS Available Admission Capacity |
| 29 | BSS AC Access Delay |
| 30 | Measurement Pilot Transmission |
| 31 | Multiple BSSID |
| 32 | RM Enabled Capabilities |
| 33 | Mobility Domain |
| 34 | DSE registered location |
| 35 | Extended Channel Switch |
| | Announcement |
| 36 | Supported Operating Classes |
| 37 | HT Capabilities |
| 38 | HT Operation |
| 39 | 20/40 BSS Coexistence |
| 40 | Overlapping BSS Scan Parameters |
| 41 | Extended Capabilities |
| 42 | FMS Descriptor |
| 43 | QoS Traffic Capability |
| 44 | Time Advertisement |
| 45 | Interworking |
| 46 | Advertisement Protocol |
| 47 | Roaming Consortium |
| 48 | Emergency Alert Identifier |
| 49 | Mesh ID |
| 50 | Mesh Configuration |
| 51 | Mesh Awake Window |
| 52 | Beacon Timing |
| 53 | MCCAOP Advertisement Overview |
| 54 | MCCAOP Advertisement |
| 55 | Mesh Channel Switch Parameters |
| Last | Vendor Specific |

The following shows the Wi-Fi Disassociation packet frame body format.

| Order | Information |
|---|---|
| 1 | Reason code |
| 2 - (Last - 1) | Optional one or more vendor-specific |
| | elements |
| Last | The Management MIC element (MME) |

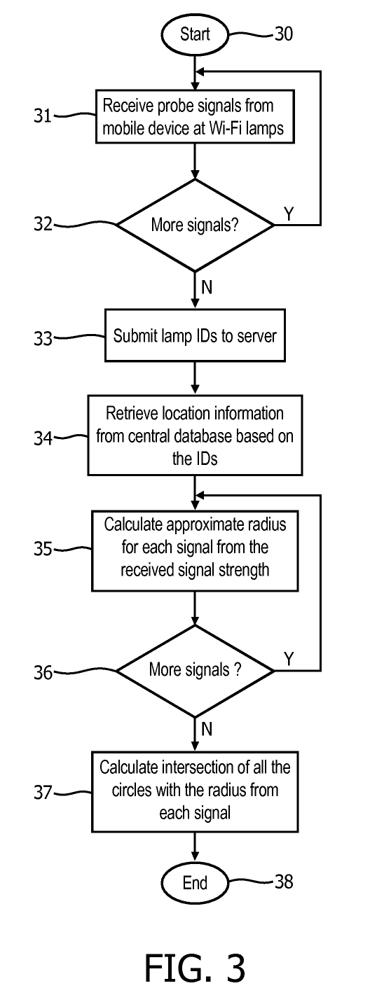

FIGS. 2 and 3 illustrate a radio based trilateration process, which may be used to calculate the location of the mobile device. FIG. 10 illustrates the circle-circle intersect used in the trilateration calculation. It will be appreciated that this is only one example of a location calculation, and other forms of location calculation such as trilateration, multilateration and fingerprinting are (in themselves) also known to a person skilled in the art.

In the process illustrated in FIG. 2, the location of the mobile device 41 is computed based on the distance R1, R2, R3 between the mobile device 41 and at least three of the lamps (nodes) 44 respectively (determined form received signal strength or time-of-flight), given knowledge of the locations (x1, y1); (x2, y2); (x3, y3) of the three or more nodes 14 respectively (as known from the location database).

FIG. 3 gives a flow chart of a radio-based trilateration process. At step 30 the process begins. At step 31, the mobile phone 41 sends one or more probe request signals, which is/are received by a plurality of the Wi-Fi lamps 44 in range. At step 32 it may be determined whether any more such signals are available and/or required. If so, the process loops back to step 31. Otherwise the process proceeds to step 33 where the Wi-Fi lamps submit their IDs to the location server 42. At step 34, the server retrieves the coordinates of the lamps 44 from its location database. At step 35 each lamp 44 calculates its respective approximate radius from the mobile phone 41 based on a measure of the received signal strength (e.g., RSSI), or alternatively submits its measurement to the server 41 for the radius to be calculated there. At step 36, it may be determined whether any more of such signals are required to be included in the calculation, and if so the process loops back to step 35. Otherwise the process proceeds to step 37 where the location server 42 calculates the intersection of all the circles defined by the radius of the phone 41 from each lamp 44 being used (see FIG. 2). At step 38 the process ends. Note that FIG. 3 is somewhat schematic and where steps in FIG. 3 involve different lamps 44, the lamps 44 do not necessarily have to all perform the steps at the same stage in the order shown (e.g., one lamp could submit its ID and distance measurements to the server before another of the lamps has received a probe request).

The following illustrates typical fields in a location database:

Finger print of network/device
Latitude
Longitude
Altitude (optional)

The following illustrates typical path loss models for determining distance between RF emitter and receiver.
1. one-slope model:

Pᵣ(dBₘ)=Pₜ(dBₘ)+K(dB)−10n log₁₀ (d/d₀)
2. indoor path loss model:

PL=20 log₁₀ (f)+10 n log₁₀ (d)+Lf(n)−28 dB
3. 2.4 GHz indoor (same floor) path loss model:

PL=39.6+10 n log₁₀ (d)

At least three reference nodes 44 are needed for radio trilateration, in order to calculate the geometry on a 2D surface (see FIG. 2) (or at least without combining with other techniques such as dead-reckoning). The server 42 retrieves the locations of the identified lamps 44 (x1, y1); (x2, y2); (x3, y3) from the location database on the server 42, and also receives or calculates the relative distances R1, R2, R3 from the mobile phone 41 to each of the lamps 44. The server 42 then obtains the geolocation of the mobile phone 41 from the trilateration (or triangulation, multilateration or fingerprinting) performed based on these distances R1, R2, R3 and reference locations 14 (x1, y1); (x2, y2); (x3, y3). This is returned to the mobile phone 41, which can then display the determined location on a map or floorplan.

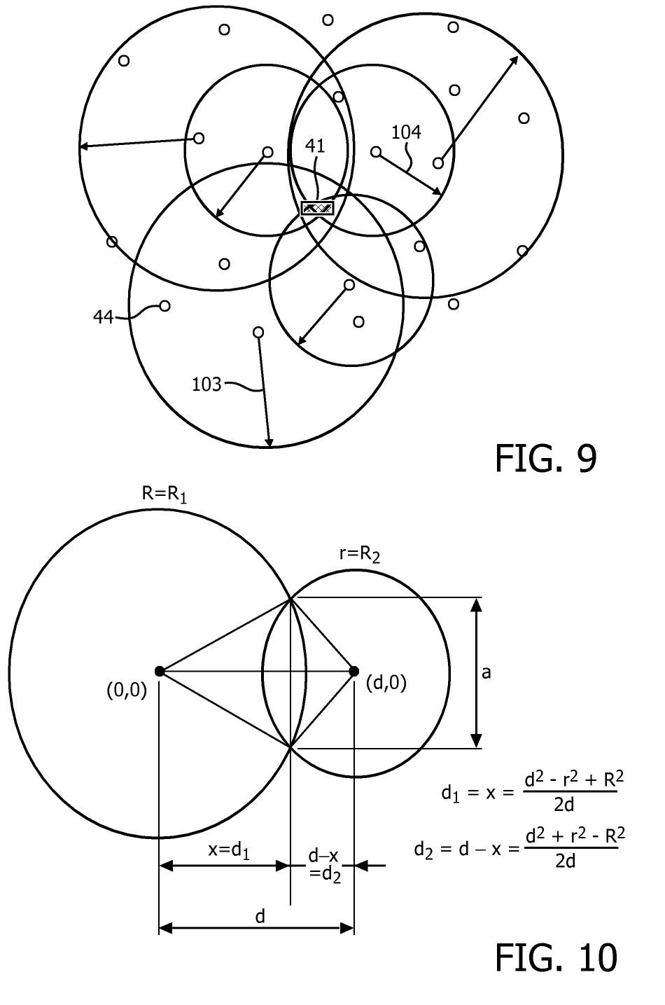

FIG. 9 gives an illustration of how more Wi-Fi nodes can improve speed and accuracy of trilateration. As lamps are usually quite densely packed in a building, the use of Wi-Fi lamps for localization is therefore ad advantageous choice.

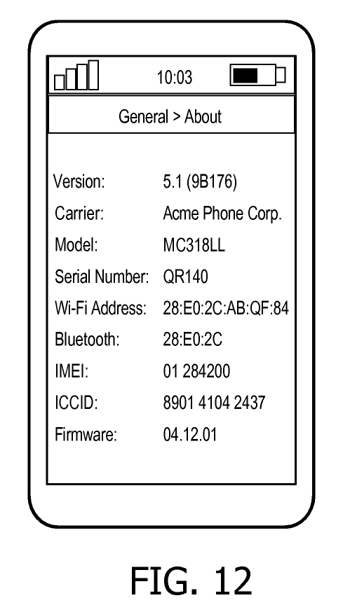

FIG. 11 shows screen-shots of an operating system when manually entering an SSID of a hidden network, thereby causing an active scan based in this SSID, and, in embodiments of the present disclosure, thereby triggering a location measurement process at a plurality of Wi-Fi lamps 44 within range when the pseudo SSID of the location service is entered. FIG. 12 shows operating system MAC address information being displayed to the user in an “About” screen of the operating system. Note: in alternative embodiments, the SSID could be pre-programmed in the app and the active scan may be triggered automatically by the app, without the user having to manually enter the SSID.

Some more example details for the design of the Wi-Fi lamps are now discussed.

As illustrated in FIG. 5, a microprocessor or MCU 51 is embedded into the lamp 41, and a Wi-Fi transceiver 52 is connected to the MCU 51. The Wi-Fi transceiver 52 may support multiple RF bands depending on the selected transceiver platform. The MCU 51 is responsible for sending and receiving the Wi-Fi packets over the air through the Wi-Fi transceiver 52, implementing the Wi-Fi standard protocols, and at the same time controlling the lamp system functions, e.g., driving the LEDs 53.

In addition, the MCU 51 is used to implement the location service. This involves listening for the Wi-Fi probing request packet or the association request packet with the special SSID, sent from the smart phone 41, or named as the location service request. The SSID string from the probing request packet or the association request packet is examined, and if this SSID string is matched to the predefined string, such as “[Location Service] Wi-Fi lamps”, then this is recognized as a location service request. The MAC address and received signal strength indicator (RSSI) of the received packet will then be recorded.

In embodiments, the MCU 51 also calculates the distance between the smart phone 41 and the Wi-Fi lamp 44 (using the method as described above or other suitable method), and sends the result along with the MAC address of the smart phone 41 to the Wi-Fi lamp managing server (location server) 42. The MCU 51 then waits for instructions from the Wi-Fi lamp managing server 42 and, if requested, switches the Wi-Fi lamp 44 into a simplified Wi-Fi access point mode. In embodiments, this mode provides an open Wi-Fi network with the minimal functions required by the Wi-Fi standard, so that this simplified Wi-Fi access point will be recognized by any smart phone that is Wi-Fi standard compliant, but only a limited number of client devices are allowed to connect to this simplified Wi-Fi access point. In the simplified Wi-Fi access point mode, the Wi-Fi lamp 44 will send out Wi-Fi periodic beacons mimicking a standard Wi-Fi access point, but the beacon will carry minimal information in order to reduce the traffic impact to the available network channel, such as by only containing the MAC address and capability of the access point. Preferably no SSID is embedded in the beacon, so that this simplified Wi-Fi access point is a hidden Wi-Fi network, to prevent connection requests from other Wi-Fi clients that are not location service oriented.

The MCU 51 will then help to forward the packet exchanges between the smart phone 41 and the Wi-Fi lamp managing server 42. These may include for example for: the Wi-Fi association and disassociation process, DHCP (dynamic host configuration protocol), DNS (domain name service), TCP/IP transport, and/or the location service itself (information or database access). If requested by the Wi-Fi lamp managing server 42, the Wi-Fi lamp 44 can stop this simplified Wi-Fi access point mode, by disassociating the connected client devices 41 first, and then stopping sending out the beacons. In embodiments, if client devices are timed out for maintaining the Wi-Fi connection sessions, the Wi-Fi lamp 44 will automatically disconnect those client devices, and the Wi-Fi lamp managing server 42 will be notified, so that an out-of-sight or switched-off smart phone 41 will be removed from the location service.

The added location service on the Wi-Fi lamps 44 will not interfere the normal wireless control functions of those Wi-Fi lamps 44, such as switching on or off the lamps 44 or dimming the lamps 44. This is achieved by implementing the Wi-Fi client and Wi-Fi access point function at the same time in one Wi-Fi lamp 44. The Wi-Fi client function is used to connect to the Wi-Fi lamp network to send and receive packets to the Wi-Fi lamp managing server 42 (see FIG. 6).

A standard Wi-Fi access point 72 is used to connect all nearby Wi-Fi lamps 44. The Wi-Fi lamps 44 thus connected will use the same Wi-Fi RF band as supported by this standard Wi-Fi access point 72. E.g., if there is only one RF band in the Wi-Fi lamp 44, there will be only one Wi-Fi channel for all Wi-Fi lamps 44. If the Wi-Fi lamp supports more than one RF band, different Wi-Fi lamps 44 may use different Wi-Fi channels to connect to this standard Wi-Fi access point 72 as long as it supports the same RF band. More Wi-Fi channels will improve the reliability of the communication. The connected Wi-Fi lamps 44 will maintain the Wi-Fi connection sessions by periodically pinging this standard Wi-Fi access point 72.

The Wi-Fi lamp 44 will implement the simplified Wi-Fi access point at the same time. This simplified Wi-Fi access point will use the same Wi-Fi channel as for the Wi-Fi client function, if there is only one RF band supported by the Wi-Fi lamp 44. If there is more than one RF band in the Wi-Fi lamp, the Wi-Fi lamp 44 may choose to start the simplified Wi-Fi access point at different channel as the Wi-Fi client. The Wi-Fi lamp 44 will always listen for the location service request on the same channel used for the Wi-Fi client, and the Wi-Fi lamp 44 may also be configured to listen for the location service request on one or more other channels at the same time. Each supported RF band may choose one Wi-Fi channel. When a location service request is captured from the same smart phone 41 but from different channels, the best receiving signal quality channel is preferably used to start the simplified Wi-Fi access point service for that smart phone 41. In some embodiments, a Wi-Fi lamp 44 that supports more than one RF band may start multiple simplified Wi-Fi access point services at the same time, to support multiple smart phones 41 on different Wi-Fi channels.

In embodiments, different Wi-Fi lamps 44 may be configured to operate on different channels so as to improve the speed and reliability of the location service, since: (i) smart phones 41 may choose different Wi-Fi channels to start sending the location service request, (ii) background RF interference may block some of the location service requests on different channels at different moments in time, and/or (iii) more listening channels can improve the speed of capturing the location service request.

The following shows an example format for the distance report from a Wi-Fi lamp 44.

Wi-Fi lamp ID
Smart phone MAC address
Distance
Time stamp

The distance calculation result calculated at the Wi-Fi lamp is formed as a report and is sent to the Wi-Fi lamp managing server 42. Each received probing request or association request packet from the smart phone 41 is analyzed and used to calculate the distance. If this is a new smart phone in the internal database, this report is sent immediately to the server 42. If there is already a record for this phone, and if the new packet yields a distance same or similar (difference less than Dₑᵣᵣ, as the distance calculation method has some margin) as previous record, the report is ignored. If the new packet yields a distance different than the previous record, the report will be sent immediately, and the new packet will be recorded. When the Wi-Fi lamp 44 is already in the simplified Wi-Fi access point mode, then each received data packet will be analyzed and follow the same reporting procedure as above. When there is a prolonged time (T_{idle}) of not receiving any packet from a smart phone in the database, the records for this smart phone in the database will be removed.

Some more example details of the Wi-Fi lamp network are now discussed.

As illustrated in FIG. 6, all Wi-Fi lamps 44 are connect to the same IP network by using one or more standard Wi-Fi access points 72. All the Wi-Fi access points 72 are connected using a backbone network 74, usually a wired Ethernet network, to which the Wi-Fi lamp managing server 42 is also connected. The Wi-Fi lamps 44 can thereby exchange information with the Wi-Fi lamp managing server 42 using standard IP protocol, such as TCP/IP through this backbone network 74.

Different standard Wi-Fi access points 72 may select different Wi-Fi channels to improve the communication reliability and provide more channel coverage for the Wi-Fi lamps 44 to capture the location service requests sent from the smart phone 41 on different channels, or from different smart phones.

When multiple standard Wi-Fi access points 72 are used, the layout of the Wi-Fi lamps 44 and the standard Wi-Fi access points 72 can be interleaved to provide channel coverage over a large area evenly. E.g., in an office inside a large building, if there is more than one standard Wi-Fi access point 72 are installed, then the connected Wi-Fi lamps 44 can be arranged so that at any given location on the floor, there will be Wi-Fi lamps nearby and connected to different standard Wi-Fi access points 72 and using different channels.

Some more example details of the Wi-Fi lamp managing server 42 (location server) are now discussed.

This location service server 42 is used to decide which of the Wi-Fi lamps 44 is to switch to the simplified Wi-Fi access point mode and when to switch it off; and to decide which Wi-Fi lamp 44 is allowed to associate or disassociate with a smart phone 41; and to collect the distance calculation results from all Wi-Fi lamps 44 and perform the actual trilateration (or other such location calculation). The server 42 will also implement the Wi-Fi protocols for all the simplified Wi-Fi access points in all Wi-Fi lamps 44, so that the smart phones 41 will be able to connect to this Wi-Fi lamp network and communicate with the server 42 to retrieve the location calculation results, and/or obtain other information, like the building structure for navigation.

The procedure to determine which of the Wi-Fi lamps 44 should have the simplified access point mode switched on or off, and which Wi-Fi lamp 44 is allowed to associate or disassociate with a smart phone 41, may be as follows. If the distance report sent from a Wi-Fi lamp 44 is shorter than a threshold of near distance (Dₙₑₐᵣ), the first Wi-Fi lamp which sends the distance information will need to check whether to associate to the smart phone 41. If there is another Wi-Fi lamp 44 already associated to the same smart phone, and if the distance to that Wi-Fi lamp 44 is longer than the threshold of near distance, that Wi-Fi lamp will need to disassociate the smart phone 41 immediately before the phone associates to the new Wi-Fi lamp. But if the distance to that Wi-Fi lamp is also shorter than the threshold of near distance, then if the new Wi-Fi lamp has shorter distance, the new Wi-Fi lamp will only associate the smart phone 41 after a grace period (T _{grace}), which allows time to check if there are any more reports received and with even shorter distance, and to prevent quick switching between Wi-Fi lamps 44. If the new Wi-Fi lamp has a longer distance than the currently associated lamp, the report is ignored. If there are no other Wi-Fi lamps currently in the access point mode, the new Wi-Fi lamp will associate with the smart phone 41.

If there is new distance information received and it is a longer distance than the threshold of near distance (Dₙₑₐᵣ), the server 42 will search previous records for a shortest distance Wi-Fi lamp. If there is another Wi-Fi lamp is already associated, and the new distance is shorter, the server waits for a grace period, disassociates the other Wi-Fi lamp, and associate the new Wi-Fi lamp (and if there is new report received during the grace period, repeat the above procedure). If the new distance is longer than the already-associated lamp, this report is ignored. If there is no other Wi-Fi lamp associated for this smart phone 41, the shortest distance is searched and analyzed. If this shortest distance is shorter than a threshold of far distance (D_{far}), then the Wi-Fi lamp with the shortest distance will associate to the smart phone 41. If this shortest distance is longer than the threshold of far distance, the report is ignored and no Wi-Fi lamp is associated, since the smart phone could be too far away to reach the Wi-Fi lamp location service network.

If a Wi-Fi lamp 44 is requested to associate (connect) with a smart phone 41 and it is not already switched into the simplified Wi-Fi access point mode, the Wi-Fi lamp 44 will switch to the simplified Wi-Fi access point mode immediately, and associate to the smart phone 41.

If a Wi-Fi lamp 44 is requested to disassociate (disconnect) from a smart phone 41, and this Wi-Fi lamp has no other smart phone connected, then this Wi-Fi lamp will switch off the simplified Wi-Fi access point mode immediately. If there are still one or more other smart phones associated with this Wi-Fi lamp, then only the specified smart phone is disassociated, and the Wi-Fi lamp is still kept in the simplified Wi-Fi access point mode.

When the Wi-Fi lamp 44 is associating and disassociating a smart phone 41, it will follow the Wi-Fi standard to handle the complete procedure for association request and disassociation request, by exchanging the matching Wi-Fi packets between the Wi-Fi lamp 44 and the smart phone 41.

Some further example details concerning the handling of Wi-Fi networking protocols in the Wi-Fi lamp managing server 42 will now be discussed.

The server 42 will implement most of the Wi-Fi and networking protocols for the Wi-Fi lamps 44, since the MCU 51 processing power in the Wi-Fi lamp 44 is limited, for cost reason etc., while the server 42 can have much more horse power for handling the functions for all the Wi-Fi lamps 44. The server 42 will implement bare minimal Wi-Fi and networking protocols for the smart phone 41, so that the lamp 44 will be recognized as an almost genuine standard Wi-Fi access point with limited functionalities, to allow maximum compatibility with a smart phone 41 on the market; to the smart phone 41, the Wi-Fi lamp 44 plus the server 42 will act as a Wi-Fi access point and network router. Specifically, the server 42 will perform the following protocols for the Wi-Fi lamp 44.

Regarding the Wi-Fi association and disassociation process by which the smart phone 41 establishes the Wi-Fi link with the lamp 44, the Wi-Fi lamp 44 will handle the association packet exchange between Wi-Fi lamp 44 and the smart phone 41, and the server 42 will decide whether an association request from a smart phone 41 is allowed or not. The Wi-Fi lamp 44 will handle the disassociation packet exchange between the Wi-Fi lamp and the smart phone 41, and the server 42 will decide whether to start the disassociation procedure to a smart phone 41.

Once a smart phone 41 is connected to the Wi-Fi lamp 44, the Wi-Fi lamp 44 is responsible for maintaining the Wi-Fi connection, and exchanging the packets between Wi-Fi lamp managing server 42 and the smart phone 41. If the smart phone 41 is timed out and leaves the network, the Wi-Fi lamp 44 will disassociate the smart phone 41 and notify the Wi-Fi lamp managing server 42. If there is packet from the Wi-Fi lamp managing server 42 designated to the smart phone 41, the Wi-Fi lamp 44 will try to deliver the packet to the smart phone 41, and buffer the packet if the smart phone is temporarily out of reach. If the packet fails to reach to the smart phone 41, the result will be notified to the Wi-Fi lamp managing server 42, and the server 42 will retry, and if this fails again, the server 42 will disassociate the smart phone 41. If there is a packet from smart phone 41 designated to the Wi-Fi lamp managing server 42, the Wi-Fi lamp 44 will forward to the server 42, and if this fails, the result will be notified to the smart phone 41.

Regarding DHCP (dynamic host configuration protocol), the Wi-Fi lamp managing server 42 will act as a DHCP server, and allocate network addresses for all the smart phones 41 connected to the network. Different smart phones 41 will have different unique addresses. All smart phones will have the same gateway and DNS server address. The Wi-Fi lamp 44 will forward all the packet exchanges for DHCP request and reply between the smart phone 41 and the Wi-Fi lamp managing server 42.

Regarding the DNS (domain name service), the Wi-Fi lamp network will implement a special DNS server function to allow certain smart phone 41 to recognize the Wi-Fi lamp network as a normal Internet connected network (e.g., some smart phones disconnect the network if they fail to locate certain pre-defined Internet servers). All the DNS requests will be resolved to return the Wi-Fi lamp managing server address.

Regarding TCP/IP transport, all the TCP/IP packets are tunneled via the Wi-Fi lamp 44 between the smart phone 41 and the Wi-Fi lamp managing server 42. In embodiments the Wi-Fi lamp 44 will not send any data content of its own to the smart phone 41 (as opposed to data originating from the server 42), and/or will not process any data content from the smart phone 41 other than the probe request which triggers the measurement process (as opposed to forwarding such data to the server 42 to be processes). And/or, in embodiments, the Wi-fi lamp 44 will not exchange data between any other components of the system, other than between the server 42 and phone 41, e.g., will not exchange data between different smart phones.

The Wi-Fi lamp managing server 42 will expose a service at a pre-defined port in the server for the location service requests, e.g., the current location of the smart phone may be obtained from a URL such as: http://server_addr:server_port/location_information, and the building structure map may be obtained from a URL such as: http://server_addr:server_port/map_information. The location service (information or database access) is built on top of the standard IP protocol, and the application in the server 42 is responsible for providing the reply for the location service requests sent from the smart phones.

The procedure to collect and store the reports from Wi-Fi lamps 44 is as follows. The server 42 will record all the reports from Wi-Fi lamps 44 to a database. All records are time stamped, and each record will expire in a pre-determined time (Tₑₓₚᵢᵣₑ). After expiration, the record is removed from the database. The database is indexed by the Wi-Fi lamp IDs and the smart phone MAC addresses. For a given Wi-Fi lamp 44, all the reports associated with the specified smart phone 41 can be searched and obtained. The database can also implement MAC address filter function, to implement security features, like allowing only a specific range of smart phones to use the location service or disallow certain smart phones.

Regarding the commissioning of Wi-Fi lamps 44, when the Wi-Fi lamps are installed inside the building, then the absolute location of each of the Wi-Fi lamp 44 is measured and saved into the Wi-Fi lamp managing server 42 in the Wi-Fi lamp location database. The absolute location of each of the Wi-Fi lamp 44 can be obtained by using means such as a building floor plan, etc.

The following now provides a note with regard to the location calculation when there are many Wi-Fi lamps 44.

The location of a smart phone 41 is calculated when there are one or more distance reports from the Wi-Fi lamp 44 for the same smart phone. If there is one report, the location of the smart phone 41 is estimated to be the same as the reporting Wi-Fi lamp 44, with the calculation error same as the distance given in the report. If there are two reports, the location of the smart phone is calculated by assuming the two distance are R1 and R2, and using formula in FIG. 10, the distances d₁ and d₂ are obtained. The location of the smart phone is the points on the line connecting the two Wi-Fi lamps which have sent the reports, proportionally at the position divided by distance of d₁ and d₂. The calculation error will be (R₁ and R₂)/2. If there are three reports, the location of the smart phone can be trilaterated using traditionally method as illustrated in FIG. 2. The result could be in three categories: (i) the smart phone location cannot be determined, since the calculation of distances in the reports yields unstable result; (ii) the smart phone location is found, with very high calculation error that the location beyond the building size or the size of area interested; or (ii) the smart phone location is found, with acceptable calculation error.

If there are more than three reports, the location server 42 selects three reports which are generated from three Wi-Fi lamps 44 that are located outmost on a building floor, as illustrated in FIG. 9, in order to quickly determine the rough location of the smart phone 41, such as whether the smart phone is even located inside the building. For any combination of the three reports from all reports, the server trilaterates each of them, and generates a location with certain calculation error. If all results are “cannot be determined”, the overall result is “cannot be determined”. If no result is “can determine” with “acceptable calculation error”, the overall result is same as “can determine” with the shortest “high calculation error”, or “cannot be determined” if there are no “can determine” results. If there is one result of “can determine” with “acceptable calculation error”, this is used as the overall result. If there is more than one result of “can determine” with “acceptable calculation error”, then there are two options: (i) use the one “can determine” with the shortest “acceptable calculation error” as the overall result, or (ii) average the results of all the results of “can determine” with the “acceptable calculation error” (the center of a smallest circle that covers all the results is the location, with the average of the all the calculation errors giving the calculation error).

The following provides some example detail of the smart phone location service app design.

The above mechanism allows a smart phone 41 using standard Wi-Fi protocol to communicate with the Wi-Fi lamp network to access the location service. There is no need to implement any of the special Wi-Fi protocol at the smart phone side. A smart phone app will only use standard IP layer communication to exchange the data between the smart phone app and the location service server 42.

The app will first need to switch the smart phone to the hidden Wi-Fi network specified by the special SSID, and in the nearest Wi-Fi lamp 44 will automatically create a simplified Wi-Fi access point, allowing the smart phone 41 to connect to the Wi-Fi lamp network.

For certain smart phones, the smart phone app may ask user to switch to the special SSID network. For example, the operating system may not allow programmatically switching between Wi-Fi networks, so the user has to enter the SSID, as illustrated in FIG. 11. If there is no other Wi-Fi network currently selected in the smart phone, the smart phone will next time always to connect to this special network. If there is another Wi-Fi network currently selected in the smart phone, the smart phone user has to manually switch the network to the special location service network.

When the smart phone 41 is switched to the special location network, the previous smart phone Wi-Fi data communication to the Internet is dropped. The availability of new data link to the Internet depends on the policy of the location service server 42, which could forward normal Internet traffic if the policy allows.

The smart phone app will then try to connect to the special URL as predefined by the location service server 42. If there is a response, then the app can be assured the location service server is available.

Once connected to the special network, the smart phone app can periodically pull the calculated location from the location service server 42.

The smart phone app may ask the user to register for this service over the Internet, such that the location service server 42 can grant the access rights to the smart phone 41. For certain smart phones or operating systems, the phone cannot retrieve the device MAC address programmatically, so the smart phone user has to copy the MAC address from the smart phone settings menu to register, as illustrated in FIG. 12.

Finally, a note on the location service usage and user interaction: this Wi-Fi lamp based smart phone location service may require the user to install a special app onto the smart phone 41. This app will either automatically invoke the location service, or do so via a user intervention for certain makes and/or models of smart phones and/or operating systems, such as by manually enter the SSID for the hidden network. The user may have to specially activate this app before use, and for certain phones and/or operating systems, the user may have to manually switch to a hidden Wi-Fi network. User registration may also be required, and for certain phones and/or operating systems, the user may have to manually copy the phone MAC address to proceed.

Once the service is activated and the hidden network is connected, the navigation map will automatically update the smart phone location.

It will be appreciated that the above embodiments have been described only by way of example.

For instance, while above it has been described that the lamp 44 calculates the distance to the mobile phone 11 based on the signal measurement, and reports the distance to the location server 42, in alternative embodiments the lamp 44 may instead report the raw measurement to the location server 42 for the distance to be calculated there. Further, although in the above the actual location calculation (e.g., triangulation, trilateration, multilateration and/or fingerprinting based technique) is performed at a location server, in alternative embodiments the distances or raw signal measurements could instead be reported to a particulars one of the lamps 44 or the mobile device 41 and the location calculation performed at that lamp 44 or device 41 (and in some embodiments a server 42 may not necessarily be needed at all).

Further, while the above has been described in terms of using Wi-fi lamps as the nodes of the location system, in other embodiments the nodes could alternatively or additionally comprise one or more other types of Wi-Fi equipped nodes such as motion or presence sensors, daylight sensors, smoke alarms, air-conditioning units, etc. and/or dedicated localization nodes. Further, the concepts disclosed herein is not necessarily limited to Wi-Fi, and could instead be used to adapt other types of types of wireless networking protocol, e.g., ZigBee. Further, although above has been described in terms of RF, it is not excluded that other wireless modalities could be used if standardized, e.g., infrared, ultrasound, or coded visible light. Further, the scope of the present disclosure is not limited to A-GPS, and alternatively or additionally the teachings herein could provide indoor support to assist other satellite based location systems such as GLONASS or Galileo, or could be used to provide a standalone indoor and/or outdoor location system. For example, the disclosed location system could be a part of an A-GPS system, or it could be operated as a standalone indoor location system.

Further, although the above has been described in terms of a mobile phone 41, this could instead be any other type of mobile device such as a tablet, laptop or dedicated localization device (e.g., tracking tag).

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored and/or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A node of a location system, the location system providing a location service for determining a location of a mobile device, and the node comprising:
a wireless interface configured to communicate wirelessly according to a standardized wireless networking protocol, said protocol defining a request message for sending a request from the mobile device to said node, the request message having a network ID field for specifying a network to which the request is directed, and
a signal processing module operatively coupled to the wireless interface; wherein the wireless interface is operable to receive, from the mobile device, an instance of said request message including an ID of said location service, the ID of the location service being carried in said field, wherein at least at the time of receiving said instance of the request message from the mobile device, the ID of the location service is at least not an ID of any network of the wireless networking protocol for which said node currently functions as a wireless access point; and
wherein the signal processing module is configured to detect the ID of the location service in said field, and in response to said detection to register a measurement of the received instance of said request message, for use in determining the location of the mobile device in conjunction with information on measurements taken by other nodes of the location system based on instances of the request message received by the other nodes.

2. The node of claim 1, wherein: at least subsequent to receiving said instance of the request, the node is operable as an access point to provide access to a wireless network of the wireless networking protocol using said wireless interface based on a network ID of the wireless network; and wherein the signal processing module is configured to return the location of the mobile device once determined to the mobile device via said wireless access point and wireless network, based on the mobile device connecting to said access point using said network ID.

3. The node of claim 1, wherein at least at the time of receiving said instance of the request message from the mobile device, the ID of the location service is not an ID of any currently available network of the wireless networking protocol.

4. The node of claim 2, wherein:
the signal processing module is further configured to automatically activate the node to begin functioning as said wireless access point in response to said detection.

5. The node of claim 4, wherein the signal processing module is configured to only activate said node to function as said wireless access point if spatially closer to the mobile device than any of said other nodes.

6. The node of claim 3, wherein the ID of the location service is the network ID of said wireless network.

7. The node of claim 3, wherein the network ID of said wireless network is different than the ID of the location service, such that the ID of the location service is never a network ID of said wireless networking protocol.

8. The node of claim 2, wherein said node is configured not to broadcast the network ID of said wireless network.

9. The node of claim 1, wherein said wireless networking protocol is a Wi-Fi protocol.

10. The node of claim 9, wherein the ID of the location service is an SSID of the Wi-Fi protocol.

11. The node of claim 9, wherein said request message is a Wi-Fi probe request.

12. An arrangement of nodes, each configured according to claim 1.

13. The arrangement of claim 12, wherein each of a plurality of the nodes is configured to listen for the request message on a different channel of the wireless networking protocol.

14. A computer program product for use in a location system, the location system providing a location service for determining a location of a mobile device, and the computer program product comprising code embodied on a computer-readable medium and configured so as when executed on a node of the location system to perform operations of:
operating a wireless interface of said node to communicate wirelessly according to a standardized wireless networking protocol, said protocol defining a request message for sending a request from the mobile device to node, the request message having a network ID field for specifying a network to which the request is directed;
receiving, from the mobile device, an instance of said request message including an ID of said location service, the ID of the location service being carried in said field, wherein at least at the time of receiving said instance of the request message from the mobile device, the ID of the location service is at least not an ID of any network of the wireless networking protocol for which said node currently functions as a wireless access point;
detecting the ID of the location service in said field; and
in response to said detection, capturing a measurement of the received instance of said request message, for use in determining the location of the mobile device in conjunction with information on measurements taken by other nodes of the location system based on instances of the request message received by the other nodes.

15. A method of operating a node of a location system, the location system providing a location service for determining a location of a mobile device, and the method comprising:
operating a wireless interface of said node to communicate wirelessly according to a standardized wireless networking protocol, said protocol defining a request message for sending a request from the mobile device to the node, the request message having a network ID field for specifying a network to which the request is directed;
receiving, from the mobile device, an instance of said request message including an ID of said location service, the ID of the location service being carried in said field, wherein at least at the time of receiving said instance of the request message from the mobile device, the ID of the location service is at least not an ID of any network of the wireless networking protocol for which said node currently functions as a wireless access point;
detecting the ID of the location service in said field; and
in response to said detection, capturing a measurement of the received instance of said request message, for use in determining the location of the mobile device in conjunction with information on measurements taken by other nodes of the location system based on instances of the request message received by the other nodes.
